(19) United States
(12) Patent Application Publication
(10) Pub. No.: US 2012/0079993 A1
(43) Pub. Date: Apr. 5, 2012

(54) BEHAVIOURAL APPARATUS

(75) Inventors: Abdelkader Ennaceur, Durham (GB); Paul Louis Chazot, Durham (GB)

(73) Assignee: UNIVERSITY OF DURHAM, Durham (GB)

(21) Appl. No.: 13/249,808

(22) Filed: Sep. 30, 2011

Related U.S. Application Data
(60) Provisional application No. 61/388,183, filed on Sep. 30, 2010.

(51) Int. Cl. A01K 15/04

(52) U.S. Cl. 119/753

(57) ABSTRACT

An apparatus for studying the behavioural, cognitive, neurobiological and/or muscular processes of an animal, the apparatus comprising an elevated platform with at least one panel extending from the platform, said panel providing a surface which has a gradient relative to the platform. A method of studying the behavioural, cognitive, neurobiological and/or muscular processes of an animal, the method comprising placing one or more animals on the apparatus according to the invention and recording the frequency and/or duration the animal is located at one or more positions on the apparatus and/or the latency of the animal to enter an area of the apparatus.

### CROSS-REFERENCE TO RELATED APPLICATIONS

This application claims the benefit of the filing date of U.S. Provisional Patent Application No. 61/388,183 filed Sep. 30, 2010, the disclosure of which is hereby incorporated herein by reference.

### BACKGROUND OF THE INVENTION

The present invention provides an apparatus for studying the behavioural, cognitive, neurobiological and/or muscular processes of an animal, and methods using the apparatus. The apparatus and methods have much utility for assessing behavioural phenotypes, determining drug targets and screening for the efficacy and side-effects of therapeutics.

A critical stage in the development of any new treatment is the trial stage. Here a test compound drug or agent is administered to one or more test subjects, often laboratory mice and rats, in order to determine possible drug benefits and side effects. Information concerning an animal's behavioural, cognitive, neurobiological and/or muscular processes can provide valuable information concerning the efficacy and safety of the drug.

For behavioural analysis, the most frequently used tests in assessing anxiety in animals are the plus-maze, zero-maze, light-dark box and the open-field. In the plus-maze animals are released from a central area leading to four arms, two opposite arms without enclosures and the remaining opposite arms have enclosures. Animals show strong preference for the enclosed arms and rarely venture in the open arms. On subsequent exposures to the test, animals stop moving away from the enclosed arms. Because animals seem to spend a significant amount of time in the central area of the plus-maze which people find difficult to interpret its value, a zero-maze was proposed based on the same principle.

The light/dark box consists of a rectangular box which is divided in two compartments, one lit and the other dark. Animals show strong preference for the dark compartment, which is very natural and demonstrates that animals show fear-induced avoidance response of lit compartment; however this is poor evidence of fear-induced anxiety. The open-field consists of a square, rectangular or circular surface surrounded totally by walls. Animals show strong preference for walls and corners. Here also animals feel safe against walls and corners and remain there for most of a session duration.

It is considered that in the above mentioned tests, animals which do not venture into the open part of these apparatus are anxious and therefore a large proportion of time spent in the protected space is used as an index of anxiety. However, the present inventors have realised that the presence of a protective space induces escape or avoidance responses, which are distinct behaviours.

The test apparatus of the invention was initially developed to address a major problem in screening for drugs and behavioural phenotyping in rodents. This problem concerns the failure of the anxiety tests in the art to provide consistent and unequivocal results when assessing anxiety in animals, this making it difficult to discover any novel anxiolytic agents. This problem with existing tests is that they measure fear-induced avoidance or escape; they do not measure fear-induced anxiety. In addition, existing tests cannot be used in more than one session as animals stop to move in the test apparatuses.

The inventors then developed an improved apparatus to determine behavioural responses of test animals. The apparatus forms part of the present invention. The apparatus is configured very differently than those known previously and allows the user to study specific aspects of animal behaviour. The apparatus of the invention is characterised in having an elevated platform, with at least one panel extending from the platform providing a gradient. The arrangement of the features of the apparatus of the present invention is not apparent from the design of the existing apparatuses described above.

When exposed to some configurations of the apparatus of the invention the inventors demonstrated that there is a difference between fear-induced avoidance or escape and fear-induced anxiety. When introduced to the platform with two opposite panels with steep downward gradients, anxious animals spent the entire session on the platform while less anxious animals did cross onto the steep slopes. When a hub with open accesses (combined open-space and enclosed space) is placed in the centre of the platform, both anxious and less anxious animals did spend most of the time inside the hub, and they do not explore the slopes.

This statement applies to all animals, anxious and less anxious, when they are exposed to the open space of the platform. In presence of a protective space both anxious and less anxious animals, explore less the outer area. All animals spent most of the time in the areas adjacent to slopes than in the areas adjacent to a void space. The difference between these two areas is crucial to determine whether animals were able to detect the presence of the slopes and exclude any sensorial defects that would account for animals not crossing onto the slopes. Importantly, using the test apparatus the inventors have been able to test animals in 6 consecutive sessions and anxiety was observed through these sessions with no sign of habituation. This provides the chance to look at models of chronic anxiety but also examine the effect of anxiolytic drug candidates on tolerance, dependence and withdrawal.

### BRIEF SUMMARY OF THE INVENTION

The apparatus of the invention is characterised in having an elevated platform, with at least one panel extending from the platform providing a gradient. In this apparatus, all animals would experience anxiety but those that are less anxious venture onto the gradient. Hence the criterion for the measure of anxiety in test animals is based on the crossings from the platform onto a gradient: anxious animals may adventure onto the edges of the platform and spend longer time there, but those that are less anxious are expected to enter onto the gradient. Such an apparatus can be used to determine the effect of test compounds or agents on animal behaviours, since a drug with specific anxiolytic properties, rather than one which increases locomotive activity and exploration, would facilitate the entry onto the gradient.

In addition to the utility of the apparatus in measuring animal anxiety, the inventors have also realised that the apparatus can also be used for determining further behavioural, cognitive, neurobiological and/or muscular processes of an animal. It can be appreciated therefore that the apparatus of the invention has much utility, particularly in respect to screening for potential new therapeutic compounds or agents and also for determining the tolerance, dependence and withdrawal of an animal to a compound or agent affecting behavioural, cognitive, neurobiological and/or muscular processes.

These applications will be further expanded below.

An additional advantage of the apparatus of the invention is that it allows a dramatic reduction in the amount of animals required in behavioural screening, since the apparatus is a single device but can be used to measure multiple behaviours—currently this is done using a battery of a large number of tests, each requiring different animal groups (up to 10× more animals required) and a large amount of time (ranging from a day to a month per test).

Hence a first aspect of the invention provides an apparatus for studying the behavioural, cognitive, neurobiological and/or muscular processes of an animal, the apparatus comprising an elevated platform with at least one panel extending from the platform, said panel providing a surface which has a gradient relative to the platform.

Examples of the apparatus of the invention are illustrated in the accompanying figures.

### BRIEF DESCRIPTION OF THE DRAWINGS

FIG. 1: Configurations of the areas of the elevated platform with steep slopes. (A) Fear-induced anxiety test; (B) Fear-induced avoidance/escape test.

FIG. 2: Illustration of the settings of the open space elevated platform with steep slopes.

FIG. 3: Diazepam increased the number crossings (A) onto and time spent (B) on the slopes in Balb/c mice. Saline treated mice did not cross onto the slopes.

FIG. 4: Both amphetamine (A) and diazepam (B) increased the total number crossings on the surface of the platform in Balb/c mice. The number of crossings in amphetamine treated mice (5 and 10 mg/kg) is almost double of that of diazepam treated mice (0.5, 1 and 3 mg/kg) but none of the amphetamine treated mice crossed onto the slopes.

FIG. 5: (A) The number of crossings indicates preference for the areas adjacent to slopes in C57/Bl6J and CD1 mice; (B) The time in the areas adjacent to slopes indicates significant preference for these areas than for the areas adjacent to the void space in Balb/c, C57/Bl6J and CD1 mice. Note here that the apparent low number of crossings and time spent in AS and AV for both C57/Bl6J and CD1 mice is due to the fact that these strains of mice did explore the slopes while Balb/c mice spent the entire session on the platform.

FIG. 6: The presence of a protected space reduces significantly the number of crossings on the surface of the platform. It also reduces the number of crossings (A) and time spent (B) in the outer areas and increases the number of crossings and time spent in the inner+central areas of the platform in both C57/Bl6J and Balb/c mice. These indicate that both strains of mice show strong preference for the protected space.

FIG. 7: Time spent by c57/Bl6J (A) and Balb/c (B) mice in the areas adjacent to slopes (AS), in the areas adjacent to a void space (AV), and in the inner (INN) and central (CTR) areas over 3 test sessions. Note here that the apparent lower amount of time spent in AS and AV for C57/Bl6J mice is due to the fact that these mice did venture onto the slopes while Balb/c mice remained the entire session on the platform.

FIG. 8: Apparatus used for social interaction and memory tests outlined in Example 2.

### DETAILED DESCRIPTION OF THE INVENTION

A feature of the apparatus of the invention is the elevated platform. By “elevated” we mean that the platform is positioned at a distance above the ground level. The platform may be supported in its elevated position by support devices such as legs or a base. In one embodiment of the invention, there are 4 legs supporting the platform in its elevated position.

In a preferred embodiment of the invention the height of the elevated platform is adjustable. This can be readily achieved by the use of a support device than can be adjusted; for example, if legs are used then the legs may be telescopic to allow easy adjustment of the height of the platform. Alternatively, the platform can be elevated using interchangeable support devices of differing sizes, thus providing adjustable heights to the platform.

The height of the platform may be dependent on the animal to be introduced to the apparatus. In the case of rodents such as rats and mice, one consideration is that the platform should be elevated to a height such that the animal is discouraged from simply jumping from the platform to the ground. In practice this means that the height should be preferably at least 70 cm; more preferably 75 cm.

The platform can be partitioned into various areas, either physically using different types of material, or by marking with lines, or simply conceptually with no physical markings. Such areas can include a central area positioned in the middle of the platform; an inner area positioned around the central area; and an outer area extending from the periphery of the inner area to the edge of the platform. The outer area can be further divided into areas located adjacent to a panel, or areas located adjacent to a void space. A panel and a void space are explained further below.

The platform can have a range of different shapes: square; rectangular; hexagonal; round; oblong, or any other shape. Preferably the platform is square.

The platform can have a range of different sizes, depending in part on the type and number of animals to be introduced to the apparatus; and also for the experimental purpose of the use of the apparatus. As way of guidance, where the animal is a mouse, then the overall size of the platform is approximately 80 cm by 80 cm, assuming the platform is square; where the animal is a rat then the overall size of the platform is approximately 100 cm by 100 cm, assuming the platform is square.

The platform can be constructed from a range of different materials, with the material preferably being of sufficient strength to support the weight of the animal(s) to be introduced to the platform. Preferably the material is non-absorbent, thus allowing the apparatus to be readily cleaned prior to the introduction of the animal.

A further feature of the apparatus is the one or more panels extending from the platform, said panel providing a surface which has a gradient relative to the platform.

The purpose of the panel is to provide a surface that an animal may venture on to. It therefore provides a surface of sufficient size to allow the location of the animal. For example, in a preferred embodiment of the invention where the animal is to be located on the apparatus, the panel extends the length of one of the sides of a square platform and thus is 80 cm wide. Of course the panel does not have to be the same size as the platform it is connected to, it may be narrower but still provide a surface for the animal to move freely.

The panel can be connected to the platform using permanently fixing means, or optionally it can be constructed as a single piece with the platform. For example, it is envisaged that the platform and the panel can be a single piece of moulded plastic. However, preferably the panel can be adjusted to allow a variable gradient relative to the platform using variable fixing means. For example, in an embodiment of the invention provided herein the panel is connected using a series of hinges, thus allowing the angle of the gradient to be altered.

In a preferred embodiment of the invention the panel provides a gradient of between 60o to 80o, preferably 77o, relative to the platform. The inventors have determined that this angle is appropriate when the apparatus is used with rats or mice as the animals.

The panel can have an upward or downward gradient, depending on the investigative purpose of the apparatus.

The panel can be constructed of any suitable material. While it is preferable that the material can support the weight of the animal, as shown in an embodiment of the invention the panel can be substantially constructed of a relatively light material, e.g. wire mesh or grid, optionally with strengthening struts extending across its length and also connected to the support device. Other than wire mesh or grid, the panel needs to provide a non slippery surface, e.g. rough or grooved.

In an embodiment of the apparatus, the panel is constructed of a mesh or grid material. This is to allow animal waste to readily exit from the apparatus, thus making the apparatus more easy to use, but also to allow the animal to see through the panel to the ground below. By allowing the animal to view through the panel, this can provide the animal encouragement to venture on to the panel rather than remain on the platform.

In a further embodiment of the invention, the panel has two or more sections, the sections having different gradients to each other therefore providing more than one gradient in the panel relative to the platform. In this embodiment of the invention, each panel can have two or more different gradients. The inventors have determined that an animal may be tempted to venture on to the panel from the platform when presented initially with a less steep gradient, and then be encouraged to move on to the steeper gradient. The panel of this embodiment of the apparatus can be constructed as a single piece having fixed different gradients, or can be constructed such that two sections are connected by a variable fixing means such as hinges. There should be a thin dark outer rim (approx. 1 cm height) at the end of steep panel to encourage animals to venture onto panel.

In a further embodiment of the invention the panel has a stand located at the end distal from the platform, the stand providing a substantially horizontal surface. In this embodiment of the invention, the animal can move from the platform, across the panel and on to the stand. As discussed below, such a configuration can be useful for various experimental measurements. By “substantially horizontal” we mean that the stand is mainly level with the ground.

As with the panel, the stand can be constructed as a single piece with the platform and panel, for example as a single piece of moulded plastic. However, preferably the stand can be adjusted such that if the variable gradient of the panel relative to the platform is adjusted, then the stand can also be adjusted relative to the panel to allow the stand to provide the substantially horizontal surface.

In a preferred embodiment of the invention the stand is not visible to an animal located on the platform. In this way the animal may venture on to the panel without knowing what is at the end of the gradient.

A further embodiment of the apparatus is where the platform has at least one edge adjacent a void space. By “void space” we mean that there is a sheer drop from the edge of the platform to the ground. As discussed further below, the inventors have determined that the presence of a void at the edge of the platform can influence the behaviour of an animal placed on the platform. The response of the animal to such an arrangement can be used as a measure of certain behavioural responses. The number of edges being located next to a void space can be dependent on the total number of edges presented by the shape of the platform, and also the purpose of the investigative use of the apparatus.

A further embodiment of the apparatus is where a structure is placed in the central area of the apparatus. Preferably the structure is a tile or a similar object, which occupies the total surface of the central area. The tile or similar object is preferably white, but can be of any colour.

In the existing test of anxiety using an open-field, animals seem to avoid the central area. There are only rare occasions where they cross through that part of the test arena; the time spent in this area is almost insignificant. The presence of a tile increase exploration of the central area, and hence may be of use when using the apparatus of the invention in the later described testing methods.

A still further embodiment of the invention is wherein a hub is provided on the elevated platform, said hub having at least one opening to allow the passage of the animal. The hub is a location in which an animal can freely enter or exit, and can provide some animals with a sense of security from the environment of the apparatus. As discussed below, the inventors have determined that the presence of a hub in the platform can influence the behaviour of an animal placed on the platform. The response of the animal to such an arrangement can be used as a measure of certain behavioural responses. The hub can be of any shape, preferably cylindrical, and preferably having between 3 to 8 openings.

A further embodiment of the invention is wherein one or more food and/or water rewards or visual stimuli are located in the apparatus. It can be well appreciated and is known in behavioural studies that the provision of such features can be used to investigate animal behaviour. Examples of visual stimuli can include the provision of novel objects for the animal to investigate, or the displacement of known objects within the apparatus.

A preferred embodiment of the apparatus of the invention is provided in the accompanying figures. Here, the apparatus has a square platform of suitable dimensions for a mouse or rat. The platform is elevated by around 70 cm to 75 cm. Two panels are provided on opposing edges of the platform each with a downward gradient of 77o. Two void spaces are also provided on opposing edges. The platform is divided in to a central area positioned in the middle of the platform; an inner area positioned around the central area; and an outer area extending from the periphery to the inner area to the edge of the platform. The outer area is further divided into two areas located adjacent to a panel, and two areas located adjacent to a void space.

A preferred embodiment of the apparatus of the invention is provided in the accompanying figures. Here, the apparatus has a square platform of suitable dimensions for a mouse or rat. The platform is elevated by around 70 cm to 75 cm. Two panels are provided on opposing edges of the platform each with an upward gradient of 77o. Each panel has a stand at the end distal from the platform. Two void spaces are also provided on opposing edges. The platform is divided in to a central area positioned in the middle of the platform; an inner area positioned around the central area; and an outer area extending from the periphery to the inner area to the edge of the platform. The outer area is further divided into two areas located adjacent to a panel, and two areas located adjacent to a void space.

The apparatus may also be provided with panels having different gradients to each other.

As discussed above, the apparatus can be used for studying the behavioural, cognitive, neurobiological and/or muscular processes of an animal.

Hence a further aspect of the invention provides a method of studying the behavioural, cognitive, neurobiological and/or muscular processes of an animal, the method comprising placing one or more animals on the apparatus according to the invention and recording the frequency and/or duration the animal is located at one or more positions on the apparatus, and/or the latency of the animal to enter an area of the apparatus.

The apparatus can be used to determine the effect of lesions, electrical brain stimulation or other interruptive modifications to behavioural, cognitive, neurobiological and/or muscular processes of an animal. In such an embodiment of the invention, an animal having one or more of the alterations mentioned above is exposed to the apparatus of the invention, and the effect of such an alteration on the behavioural, cognitive, neurobiological and/or muscular processes of an animal is recorded. In this way, the apparatus and method of the invention clearly have great utility in determining whether such alterations have therapeutic potential, or whether such alterations have undesirable side effects, as will be appreciated by the skilled person.

Moreover, the animals to be exposed to the apparatus may have one or more “genetic modifications”. By this we include where the animal as mutations in one or more specific endogenous genes, and/or the animal is “transgenic” and hence harbours one or more non-native genes. The effect of the genetic modification(s) on the behavioural, cognitive, neurobiological and/or muscular processes of the animal can be determined using the apparatus of the invention. Again in this way, the apparatus and method of the invention clearly have great utility in determining whether such genetic modifications have therapeutic potential, or whether such modifications have undesirable side effects, as will be appreciated by the skilled person.

In one particular embodiment of the invention, the animal may have one or more genetic modifications to a gene, or the polypeptide encoded by that gene, which is a target for potential therapeutic compounds. Hence the effect of modifying that gene on behavioural, cognitive, neurobiological and/or muscular processes of the animal can be determined.

It can be appreciated that the apparatus and methods of the invention can have great utility for determining the efficacy and safely of test agents. Here, two populations of animals can be used: those that have been administered a quantity of the test agent, and a ‘control’ population who has been administered a placebo or nothing.

According, a further aspect of the invention provides a method of determining the effect of an agent on animal behavioural, cognitive, neurobiological and/or muscular processes, comprising placing one or more animals administered the test agent on the apparatus according to the invention and recording the frequency and/or duration the animal is located at one or more positions on the apparatus, and/or the latency of the animal to enter an area of the apparatus.

In this aspect of the invention the apparatus can be used for determine the effect of a test agent on the animal, e.g. a “drug screening” methods.

By “test agent” we include drugs or lead compounds. The test agent may be a drug-like compound or lead compound for the development of a drug-like compound.

The term “drug-like compound” is well known to those skilled in the art, and may include the meaning of a compound that has characteristics that may make it suitable for use in medicine, for example as the active ingredient in a medicament. Thus, for example, a drug-like compound may be a molecule that may be synthesised by the techniques of organic chemistry, less preferably by techniques of molecular biology or biochemistry, and is preferably a small molecule, which may be of less than 5000 daltons and which may be water-soluble. A drug-like compound may additionally exhibit features of selective interaction with a particular protein or proteins and be bioavailable and/or able to penetrate target cellular membranes, but it will be appreciated that these features are not essential.

The term “lead compound” is similarly well known to those skilled in the art, and may include the meaning that the compound, whilst not itself suitable for use as a drug (for example because it is only weakly potent against its intended target, non-selective in its action, unstable, poorly soluble, difficult to synthesise or has poor bioavailability) may provide a starting-point for the design of other compounds that may have more desirable characteristics.

The screening methods of the invention can be used in “library screening” methods, a term well known to those skilled in the art. Aliquots of a library may be tested for the ability to give the required result.

Also, the “test agent” to be administered to the animal can include cells or other biological material, for example viral vectors; small biological molecules (e.g. monoclonal antibodies); or sRNAi molecules, as would be understood in the art. The effect of such test agents on the behavioural, cognitive, neurobiological and/or muscular processes of the animal can be determined using the apparatus of the invention. In this way, the apparatus and method of the invention clearly have great utility in determining whether a such test agent have therapeutic potential, or whether such agents have undesirable side effects, as will be appreciated by the skilled person.

A still further aspect of the invention provides a method of measuring tolerance, dependence and withdrawal of an animal to an agent affecting behavioural, cognitive, neurobiological and/or muscular processes, comprising placing one or more animals administered the agent on the apparatus according to the invention and recording the frequency and/or duration the animal is located at one or more positions on the apparatus, and/or the latency of the animal to enter an area of the apparatus.

Hence this aspect of the invention provides a method by which the effect of chronic exposure of an animal to a test agent on that animal's behavioural, cognitive, neurobiological and/or muscular processes can be determined.

When used herein, by “animal” preferably means mammals, including rodents such as rats, mice, hamsters and guinea pigs, felines, rabbits. Preferably “animal” does not include humans.

By “behavioural, cognitive, neurobiological and/or muscular processes of an animal”, we include anxiety, object preference/discrimination, sensory perception, memory, inter-animal competition, muscle tension and grip, and central nervous system function.

The methods of the invention can use the apparatus of the first aspect of the invention to determine specific aspects of the animal(s) response. This can be determined by appropriate analysis of the data, as described below and in the accompanying examples.

Hence the methods of the invention may be specifically directed to studying the behavioural processes of the animal; in particular anxiety or social interaction, and the effect of agents such as drug compounds on those processes.

The methods of the invention may also be specifically directed to studying the cognitive processes of the animal; in particular the recognition of object/visual stimuli and location of object/visual stimuli, and therefore it can be considered a memory test for the animal.

The methods of the invention may also be specifically directed to studying the neurobiological processes of the animal; in particular sensory functions such as tactile, visual or olfactory.

The methods of the invention may also be specifically directed to studying the muscular processes of the animal; in particular muscle weakness.

In use, the user of the apparatus records the frequency and/or duration the animal is located at one or more positions on the apparatus, and/or the latency of the animal to enter an area of the apparatus. This data can be collected by manually recording the information when the animal is located on the apparatus, and/or by videoing the animal when placed on the apparatus followed by data analysis using appropriate software well known for analysing animal trials.

An important consideration of the methods of the invention is the interpretation of recorded data on the latency to enter an area of the test apparatus, the frequency and/or duration the animal is located at one or more positions on the apparatus.

In particular, the user records the number of entries, duration of entries and latency of first entry into the inner area, the area adjacent to slopes, the areas adjacent to void, and onto the slopes. An additional measure is the total number of crossings on the platform before first entry onto a slope. Most of these parameters are required for the interpretation of the results of an experiment and make the present test self-sufficient to account for the effects of an experimental manipulation on anxiety and sensory-motor functions.

The accompanying examples provide detailed information as to how to record and analyse the data derived from the apparatus of the invention and the methods of the invention to determine the behavioural, cognitive, neurobiological and/or muscular processes of the test animal.

In particular, the following considerations can be used when interpreting the data.

The apparatus of the invention has been designed in such a way that it can be used to study various aspects of behaviour, emotion and cognitive processes.

### Anxiety and Other Behaviours

Depending on the configuration and test procedures, the inventors have been able to measure emotional responses to exposure to an open space such as fear from height (moving upward or downward) and anxiety responses in presence of two or multiple alternative choices.

In the elevated platform at about 75 cm height with lowered steep slopes, anxiety is measured by latency of first entry, frequency of entries and duration of entries onto the slopes. Certain strains of animals demonstrate high level of anxiety and do not cross onto the slopes, while other strains of animals do cross easily after 2-3 min latency in a 12 min test session.

In the elevated platform at about 100 cm height with lowered steep slopes, anxiety is measured by latency of first entry, frequency of entries and duration of entries onto the slopes. At this height the number of crossing onto and time spent on the slopes is reduced in the least anxious animals while the most anxious strains remain the entire session on the platform.

In the elevated platform with slopes raised upward leading to a step-stand, most animals do climb onto the slopes but anxious animals do not cross onto the step-stand.

In presence of a refuge on the platform (a cylinder with 3 or 8 exits), both anxious and non-anxious animals show preference for the refuge and the number of crossings in animals which are less anxious is dramatically reduced which demonstrate that such configuration measure fear-induced escape or avoidance.

In this test, animals are introduced in pairs to one of the test apparatus configuration and their exploratory activity is recorded. The individual of a pair can be of comparable level of anxiety or one of the pair is more anxious that the other. When exposed to each test configuration, the crossings onto the slopes or onto the step stand is facilitated or prevented depending on the level of anxiety of one of the pair and their social status (dominant and subordinate). The least anxious mice can be from c57/BL6 (non-treated), CD-1 (non-treated) or Balb/c strains treated with diazepam. Dominant mice can be CD-1 strain.

Thus, by examining the data obtained from recording the frequency and/or duration the animal is located at one or more positions on the apparatus, and/or the latency of the animal to enter an area of the apparatus, as required by the methods of the invention described above, the user can gain a measure of the anxiety of an animal when placed on the apparatus. Hence the effect of test agents on anxiety can be determined by comparing the data for test and control animals.

The number of crossings and time spent in different areas of the platform provide an indication of the exploratory activity and patterns of animals. Also, the apparatus can be used for assessing recognition of object/visual stimuli and location of object/visual stimuli based on spontaneous exploratory activity.

Also, the apparatus can be used where animals receive food/water reward in a learning and memory task, and in the presence of an object or a visual stimulus (e.g. small flat screen monitors). The food/water can be provided manually in a cup or through a food dispenser. Objects or visual stimuli can be located on the panel stands, and food is delivered at the object or visual location(s). Objects or visual stimuli can be introduced manually or presented on miniature screen monitors.

Adjustment of the gradient of the panel can also allow the investigation of an aspect of behaviour, in which a practice of an easy task facilitates performance in a more difficult task. With one steep gradient on one side and a less steep gradient on the other side of the apparatus, anxious animals show they are able to cross on the former condition.

Learning and memory tests can be performed with individual animals or a pair of animals in various test apparatuses to assess spatial and non spatial memory, visual discrimination and delayed match/non-match to sample.

Also, the methods of the invention can be performed in conditions where animals compete against each other to obtain food or water reward; such experiments can be used as a competition task, thus providing an animal model for competition.

### Sensory

Animals with impaired sensory functions (tactile, visual or olfactory) will not be able to detect the presence of a steep gradient of a downward panel in the apparatus of the invention. Normal animals (both anxious and less anxious) do cross frequently onto and spend more time in the areas adjacent to panels than in the areas adjacent to a void space. This indicates that animals detect the presence of the panels with a gradient and consider it as an option to explore. Animals with impaired sensory functions will not be able to detect the presence of the panels with gradients; hence the number of crossings and time spent on areas adjacent to panels and areas adjacent to a void space will not differ. They are also likely to fall from the platform. Because of animal welfare regulations, it is advised that a soft carpet (polyethylene foam map about 3-5 cm thick) is laid on the ground beneath the slopes. It is preferable that it is grey or dark unicolor and covers all the visible areas of the floor within the curtain perimeter that surrounds the test apparatus.

### Muscular Processes

Animals that suffer muscle weakness or from sedation will not be able to climb up or climb down the gradients on the panels, when the gradient is around 77o. If a manipulation is thought to affect muscle tension or induce sedation, animals will be put on the far top end of a panel and check if they can hold on the mesh-wire that form a slope. Hence these measurements can be used to assess muscular processes of the animal.

A further aspect of the invention is the use of an apparatus if the invention in the method of any of the above aspects of the invention.

Furthermore, the apparatus of the invention can also be considered an animal cognitive, neurobiological and/or muscular processes investigation apparatus comprising an elevated platform with at least one panel extending from the platform, said panel providing a surface which has a gradient relative to the platform.

The following examples are provided to demonstrate particular situations and settings in which this technology may be applied and are not intended to restrict the scope of the invention and the claims included in this disclosure.

### EXAMPLE 1

### A Test Apparatus and Method of use for Assessing Anxiety and Motor Activity of Test Animals

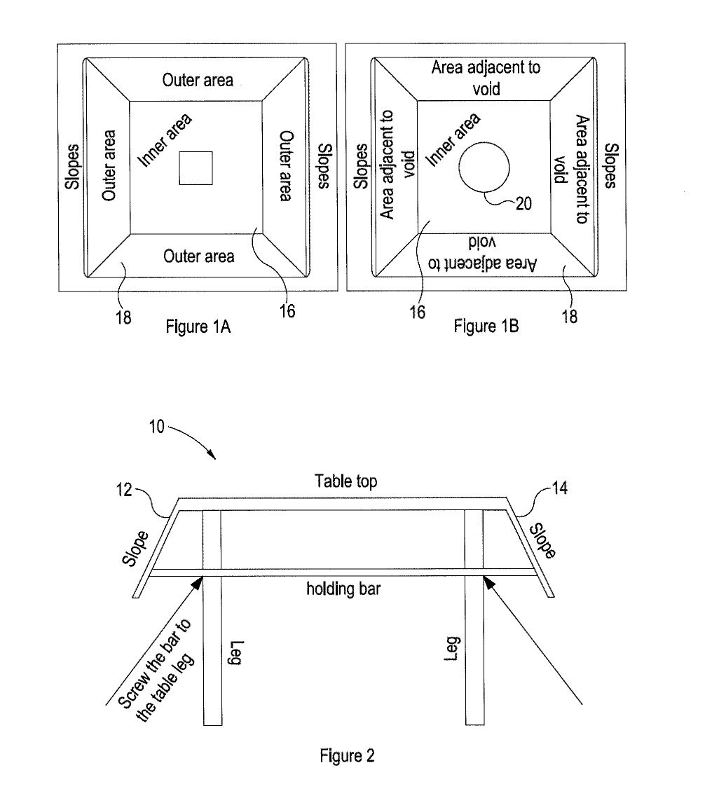

In the present report we describe a test protocol for assessing anxiety in mice and rats using an elevated platform with steep slopes attached on two opposite sides (FIG. 1A). This test provides unequivocal measures of fear-induced anxiety which are distinct from measures of fear-induced escape/avoidance response. The validity of this test is supported by the following evidence:

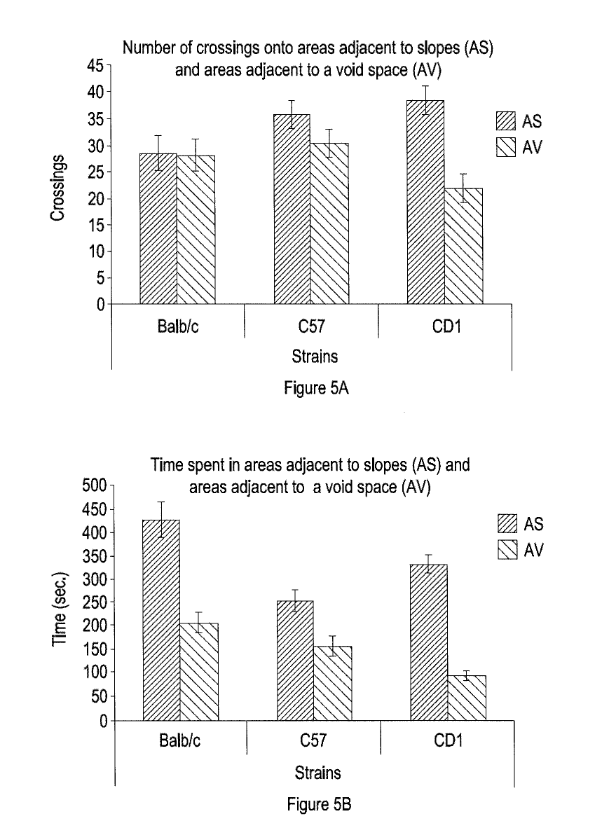

1. When exposed to an elevated platform, all animals try to escape and a large number do jump onto the ground if it is not sufficiently raised from the ground. At 75 cm height, animals do not jump onto the ground but do ‘consider’ crossing onto lowered steep slopes. Using both albinos (Balb/c and CD-1) and pigmented (C57/Bl6J, C57/Bl6N) strains of mice, we demonstrated that all mice spend more time in the outer area of the platform than in the inner and central areas, and in the areas adjacent to slopes than in the areas adjacent to a void space (3). This indicates that all mice sense the presence of the slopes and all mice appear to ‘consider’ the option of crossings onto the slopes (FIG. 5).

2. Both the platform and the slopes represent an anxiogenic environment which animals are forced to explore while trying at the same time to avoid and escape from. Animals which do cross onto the slopes, particularly those that do cross frequently onto and spend longer time on the slopes, are considered less anxious than the ones which do remain the entire session on the platform. These animals appear to take risks by crossings onto the slopes while anxious animals remain undecided, spending most of their time in the areas adjacent to the slopes. We demonstrated consistently that Balb/c mice are unable to take risks; they do not cross onto the slopes while CD1, c57/Bl6J and c57/Bl6N mice do cross onto the slopes (3).

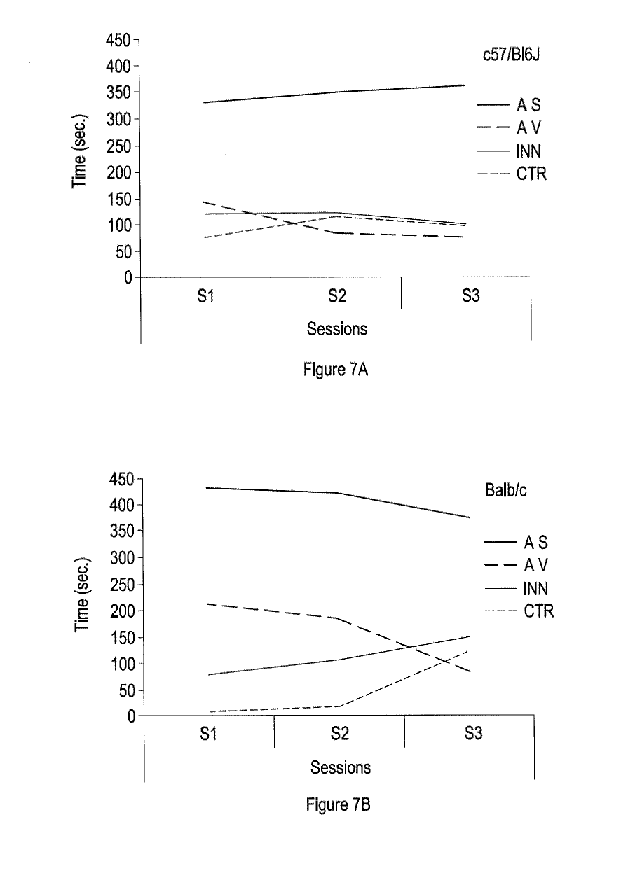

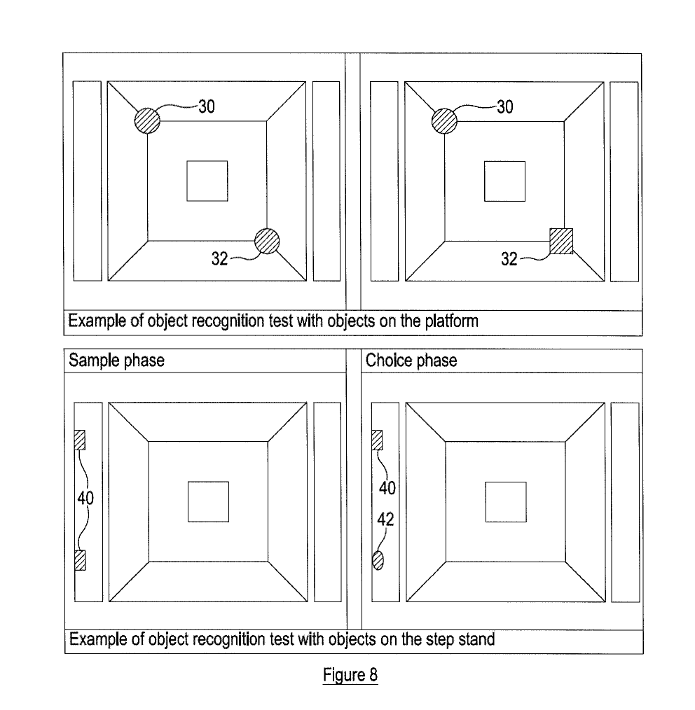

3. Balb/c mice do not cross onto the slopes even after repeated exposures to the test but do continue to explore frequently and spend a large amount of time in the areas adjacent to the slopes (3,4,5). The total number of crossings into different areas of the platform and the time spent in the areas adjacent to slopes is comparable between sessions which indicate that repeated exposures to our open space test apparatus continue to induce fear and maintain anxiety in Balb/c mice (FIG. 7).

4. In the presence of a protected space, a cylinder, in the centre of the platform (see FIG. 1B), c57/Bl6J mice appears to behave like Balb/c mice, they stop crossing onto the slopes. This protective space reduces significantly the number of entries and duration of entries into the outer area and increases the time spent in the inner and the central areas in both c57 and Balb/c mice (3). The behaviour of c57 mice demonstrates clearly that the presence of a protected space promotes the drive to avoid and reduces the drive to approach the source of potential threat.

5. Both diazepam-treated (4,5) and amphetamine-treated (4) Balb/c mice demonstrate a large significant increase in the number of crossings on the surface of the platform but only the former and none of the latter cross onto the slopes. The number of crossings on the platform in amphetamine-treated mice is almost double of that of diazepam treated mice. Hence, the test configuration prevents false positives from a drug which induces hyperactivity or impulsivity.

### 2. Materials

### 2.1. Animals:

1. Laboratory mice of most strains, transgenic and knockout mice lines. We tested so far 4 strains of mice (Balb/c, C57/Bl6J, C57/Bl6N, CD-1(ICR)). Balb/c mice display strong anxiety while C57/Bl6J, C57Bl/6N and CD-1 mice display low anxiety. Therefore, if screening for an anxiolytic treatment one will have to select Balb/c mice, otherwise if a treatment is expected to induce anxiety one will have to select c57 or CD-1 mice strains.

### 2.2. Test Apparatus for Mice

The apparatus is described in the illustration provided herein (see FIGS. 1 and 2). It consists of a platform (80 cm×80 cm wide) which is elevated 75 cm from the ground. It is made of grey opaque PVC (0.5 cm thick). Steep inclined panels (80 cm×25 cm) made of rigid wire mesh are attached on two opposite sides of the platform. From the platform the angle of depression of each slope is about 77° downward. The slopes need to be visible from the top of the platform.

The platform is divided into a central area covered with a white tile (16 cm×16 cm wide and 0.4 cm thick), an inner area surrounding the central area (16 cm wide and 2048 cm2), and an outer area (16 cm wide and 4096 cm2). The outer area is further divided into areas adjacent to the slopes (2048 cm2) and areas adjacent to the void space (2048 cm2).

A cylindrical pot can be used to provide a refuge (protected space) for animals to escape to or avoid from (16-18 cm diameter and ≧15 cm height). Animals should be able to move freely in and out through 3-5 access doors (6 cm×6 cm wide).

### 2.2. Test Apparatus for Rats

For rats, the size of the platform is 100 cm×100 cm, the width of each area is 20 cm instead of 16 cm [tile 400 cm2; inner area 3200 cm2; outer area=6400 cm2; areas adjacent to slopes 1600 x2; areas adjacent to void 1600 x2]. The dimensions and the angle of declination of the slopes remain the same as for mice. Escape or avoidance responses can be assessed using a cylindrical pot (20-22 cm diameter, ≧25 cm height) which provides a protected space in the central area. Animals should be able to move freely in and out through 3 or 5 access doors (9 cm×9 cm wide).

### 2.2.3. Test Environment

1. Ambient light—No need for strong light. It is preferable to have the same light as in the animal holding room.

2. A curtain surrounds the test apparatus. It is kept at about 50 cm from the apparatus. Use unicolored heavy curtain that falls and remains straight when released.

3. It is preferable that only depth perception rather than visual cues from the ground determines the behaviour of animals in the test apparatus. In our experiments, the floor surface within the perimeter of the curtain was almost the same color as the platform.

Most mice and rats do jump onto the ground when the platform is raised by 50 cm but not when it is raised by about 75 cm. We did not observe any mouse or rat falling from the platform at this height except in an experiment with MK-801 (at 0.2 mg/kg i.p.) which induced uncoordinated, unsteady locomotion. Hence, jumping or falling from the platform may occur in some cases. If a manipulation does induce jumping onto or falling on the ground, the experiment cannot be continued with the group of animals displaying this behaviour. Lower the doses if using drugs. One can prevent animals from sliding from the platform by using a ledge (not higher than 0.5 cm height) on each side adjacent to the void space. Do not use ledges on the sides adjacent to the slopes; animals should have free, easy access to the slopes. Keep the platform at 70-75 cm height, do not raise it further. At 100 cm height, the test is more anxiogenic (3) and it is likely to cancel its sensitivity to experimental manipulations. Because of animal welfare regulations, it is advised that a soft carpet (polyethylene foam map about 3-5 cm thick) is laid on the ground beneath the slopes. It is preferable that it is grey or dark unicolor and covers all the visible areas of the floor within the curtain perimeter that surrounds the test apparatus.

### 3. Methods

### 3.3. Behavioural Testing—Anxiety:

1. Test session 12 min. Do not use session duration shorter than 6 min as it takes about 3 min for some animals to start crossing onto the slopes. We strongly recommend a 12 min session duration. Mice can be tested in a single or multiple sessions, one session a day. The selection of the number of sessions depends on the aim of the research project. We demonstrated that anxiety is maintained over 6 sessions in Balb/c mice without signs of habituation.

One session is sufficient in drug screening for anxiolytics or in behavioural phenotyping of mice. Confirmation and consolidation of the results can be performed in 3 sessions. In research projects on tolerance, sensitization and withdrawal animals can be tested in numerous sessions. We have performed the test in 6 sessions (5) but it can be performed for much longer.

Animals can also be introduced to the test in pairs. In this case, one would expect that if one animal of a pair crosses onto the slope it would influence the other animal to do the same. For example, Balb/c mice which are not expected to cross onto the slope when alone they would be able to cross in presence of Balb/c mice treated with diazepam or in presence of c57 or CD-1 mice (which are less anxious). It is also possible that in two strains of mice that are used to cross onto the slopes, one strain would stop crossings due to being intimidated by the other strain which is aggressive.

### 3.3. Behavioural Scoring and Data Analysis:

1. Fix a transparent plastic sheet on a TV or video screen monitor. Draw clearly the visible perimeters of the areas of the platform on the sheet. Use a code name for each area (Central area=X; Inner area=I; Slopes, left=LS and right=RS; Area adjacent to slopes, left=LAS and right=RAS; Areas adjacent to void, back=BAV and front=FAV). Later during data analysis, one can combine LS with RS (S), LAS with RAS (AS) and BAV with FAV (AV) if no significant difference is observed within data pairs.

2. For manual scoring use an event log computer program.

3. The recording of the behaviour of mice is based on entries into defined areas of the apparatus. An entry is recorded whenever a mouse crosses with all four paws into an area.

4. Behavioural analysis is based on the number of entries, duration of entries and latency of first entry into the inner area, the area adjacent to slopes, the areas adjacent to void, and onto the slopes. An additional measure is the total number of crossings on the platform before first entry onto a slope. Most of these parameters are required for the interpretation of the results of an experiment and make the present test self-sufficient to account for the effects of an experimental manipulation on anxiety and sensory-motor functions.

5. For mice which did not cross onto a slope, the latency of first entry is recorded as the full duration of a session and mice are attributed the highest number of crossings before first entry onto a slope that was recorded from any mouse in that particular day's experiment.

6. In the case of slope entries, it is possible for a mouse to cross onto a slope and remain there for the remaining duration of a test session. An animal which does not return to the platform after its first entry onto a slope should be considered as anxious as the one which does not enter the slope at all. In this former case, a first entry is recorded only when a mouse returns back to the platform. If such criterion is not introduced, this mouse could be considered the least anxious compared to a mouse that moved frequently back and forth between the slopes and the platform. It would record the highest duration of entry onto the slopes, particularly if this single entry occurred early in a test session.

7. One can divide a 12 min session in 3 or 4 bins and examine how exploratory activity evolves throughout a test session.

8. Differences between groups for each measurement are examined for significance with the appropriate statistical test.

9. within group comparisons on number and duration of entries between two areas of the platform needs to be examined with paired student t-test (two-tailed) or Wilcoxon matched-pairs signed-ranks test as appropriate. These areas are of equal surface (2048 cm2):

9.1. Inner area vs. areas adjacent to the slopes

9.2. Inner area vs. areas adjacent to the void space

9.3. Areas adjacent to the slopes vs. areas adjacent to the void space

### 3.3. Behavioural Data Interpretation:

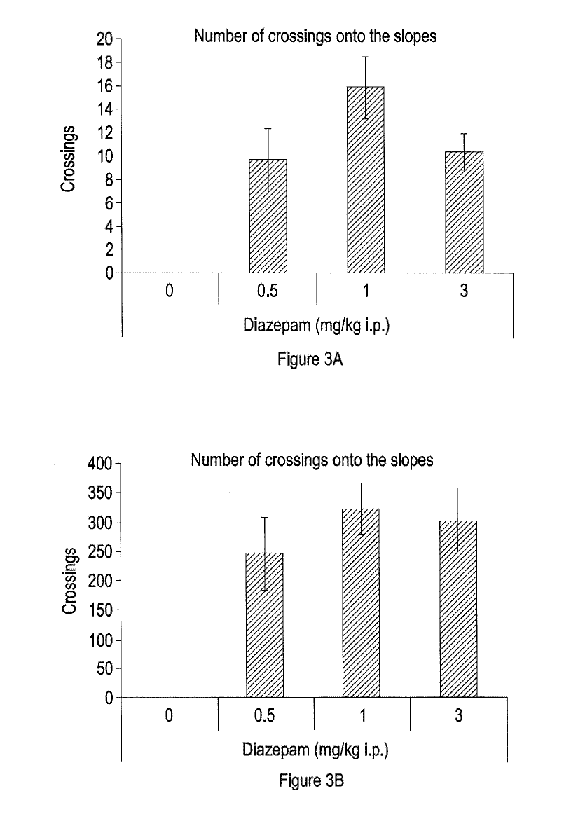

1. The number of crossings onto and time spent on the slopes are used to indicate differences in anxiety response. The measure of latency of first entry to slope is an additional parameter which can be used to indicate differences between anxious and less anxious animals. C57/Bl6J, C57Bl/6N and CD-1 mice display low anxiety (3); they cross onto the slopes. Balb/c mice display strong anxiety; they avoid the slopes (3,4,5). When treated with diazepam (0.5, 1 and 3 mg/kg i.p.) Balb/c mice do cross frequently onto the slopes and spend a large amount of time on the slopes (FIGS. 3A and B) (4,5). They do not cross onto the slopes when treated with amphetamine (1, 2.5, 5 and 10 mg/kg i.p.) (4).

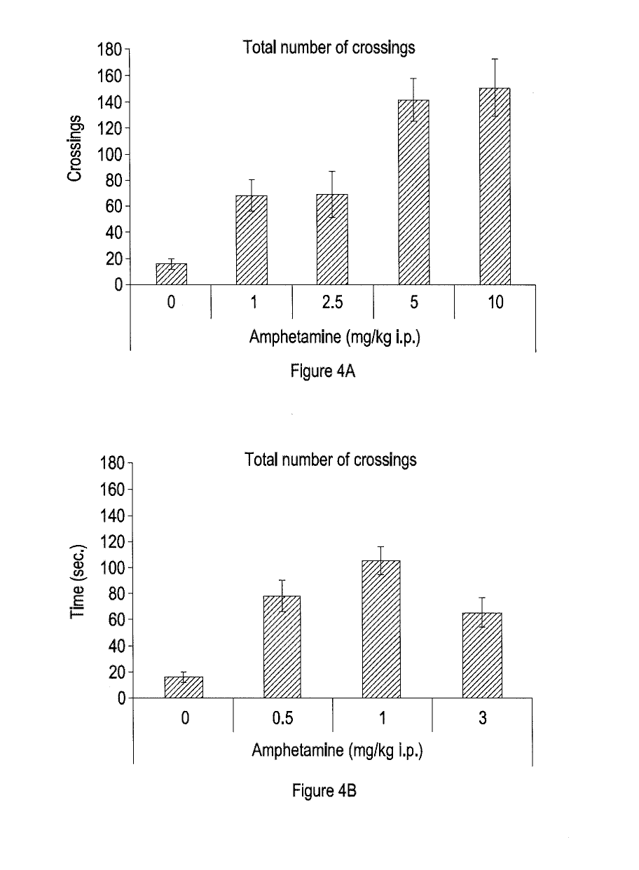

2. The total number of crossings on the surface of the platform gives some indications about motor activity though confounded with emotional responses. Diazepam and amphetamine increase dose-dependently the number of crossings on the surface of the platform in Balb/c mice (4). Amphetamine induced at least two-fold increase in motor activity compared to diazepam (FIGS. 4A and B).

3. The duration of entries into the areas adjacent to slopes compared to duration of entries into the areas adjacent to a void space help determine whether animals have been able to sense the presence of the slopes. All animals that we have tested so far demonstrated longer time spent in the former than in the latter (3,4,5).

4. Time spent in the central and inner areas are mostly useful when assessing avoidance response (3) or when testing animals for anxiety in several sessions (1,2,4).

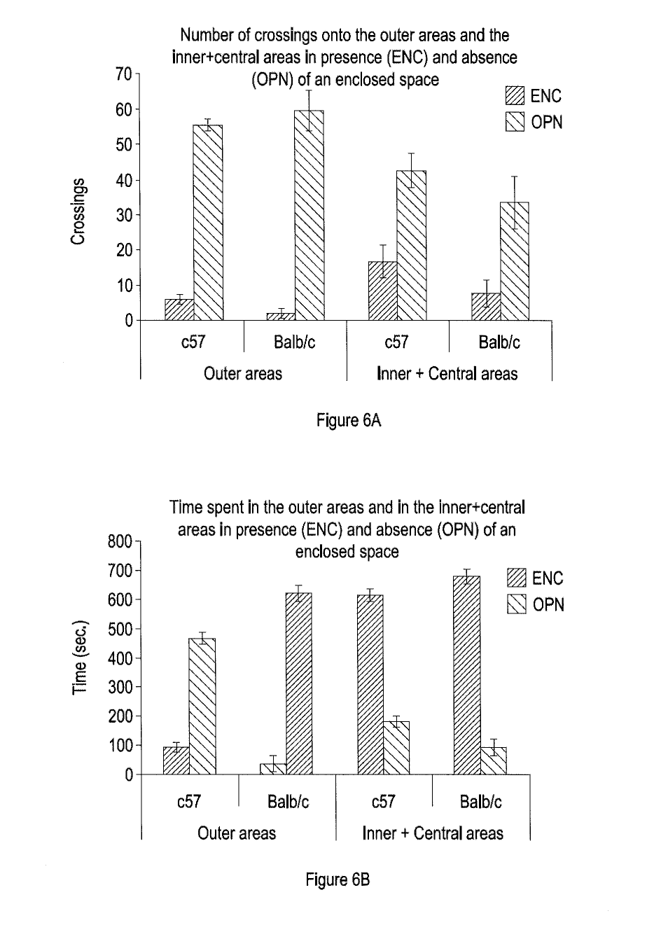

4.1. Fear-induced avoidance vs. fear-induced anxiety: When exposed to an open space, both anxious and non-anxious strains of mice cross frequently into and spend more time in the outer areas than in the inner+central areas (1,2,4) while in presence of a protected space they cross frequently into and spend more time in the central+inner areas than in the outer areas (FIGS. 6A and B). In addition, the presence of a protected space on the platform appears to discourage the least anxious strain of mice to cross onto the slopes (3).

4.2. Repeated testing: If habituation does occur the time spent in the inner and the central areas is likely to increase while the number of entries and duration of entries into the areas adjacent to slopes and to areas adjacent to a void space are likely to decrease. But this is not true for all strains of mice and habituation may not be apparent in all these test parameters (FIGS. 7A and B).

### REFERENCES

1. Shepherd, J. K., Grewal, S. S., Fletcher, A., Bill, D. J., & Dourish, C. T. (1994). Behavioural and pharmacological characterisation of the elevated “zero-maze” as an animal model of anxiety. Psychopharmacol. 116, 56-64.
2. Blanchard, D. C., Blanchard, R. J. (2008) Defensive behaviors, fear, and anxiety. In. Handbook of Anxiety and Fear, (Blanchard, R. J., Blanchard, D. C., Griebel, G., Nutt, D., Eds.), Elsevier, vol. 17, Ch. 2.4, pp. 63-79
3. Michalikova, S., van Rensburg, R., Chazot, P. L., Ennaceur, A. (2010) Anxiety responses in Balb/c, c57 and CD-1 mice exposed to a novel open space test. Behav. Brain Res. 207, 402-417
4. Ennaceur, A., Michalikova, S., van Rensburg, R., Chazot, P. L. (2010) Distinguishing anxiolysis and hyperactivity in a novel open space anxiety test. Behav. Brain Res. 207, 84-98
5. Ennaceur, A., Michalikova, S., van Rensburg, R., Chazot, P. L. (2010) Tolerance, sensitization and dependence to diazepam in Balb/c mice exposed to a novel open space anxiety test. Behav. Brain Res. 209, 154-164
6. Wu, J., Zou, H., Strong, J. A., Yu, J., Zhou, X., Xie, Q., Zhao, G., Jin, M., Yu, L. (2005) Bimodal effects of MK-801 on locomotion and stereotypy in C57BL/6 mice. Psychopharmacol. 177, 256-263

### EXAMPLE 2

### A Test Apparatus and Method of use for Assessing Social Interaction and Memory of Test Animals

### Open Space Anxiety Test

In this test animals are introduced individually to one of the test apparatus configuration and their exploratory activity is recorded. In the configuration with downward inclined slopes, Balb/c mice do not explore the slopes when they are presented at steep angles; this indicates that this strain is anxious and do not take risks. However, if one of the slopes is less steep than the other, Balb/c mice do venture in the latter after having explored the former.

In the configuration with upward inclined slopes, Balb/c mice explore the slopes but do not reach and cross onto the step-stand. This also indicates that Balb/c mice are anxious and do not take risks. As in the previous configuration, if one of the slopes is less steep than the other, Balb/c mice do venture onto the step-stand after having explored the one attached to the less steep slope.

### Social Interaction Test

In this test, animals are introduced in pairs to one of the test apparatus configuration and their exploratory activity is recorded. The individual of a pair can be of comparable level of anxiety or one of the pair is more anxious that the other. When exposed to each test configuration, the crossings onto the slopes or onto the step stand is facilitated or prevented depending on the level of anxiety of one of the pair and their social status (dominant and subordinate). The least anxious mice can be from c57/BL6 (non-treated), CD-1 (non-treated) or Balb/c strains treated with diazepam. Dominant mice can be CD-1 strain.

### Memory Tests

The tests are based on the presentation of objects to be explored and recognized according to their novelty/familiarity. Each object is presented either on the platform or on the step stand. On the platform, the objects would be placed about 15 (for mice) to 20 cm (for rats) from a corner. On the step stand, the objects would be placed at the back and 15 (for mice) to 20 cm (for rats) from the left and right side.

Object recognition: the test consists of one or more trials. A trial consists of a sample phase and a choice phase. In the sample phase animals are exposed to one object or two objects, and in the choice phase they are re-exposed to one object viewed before (familiar) and another objects never seen before (Novel). Normal animals spend more time with the novel object than with a familiar object.

Usually animals are not food deprived. However, the test can be performed with food reward and animals have to be food-deprived to run the test. The test is performed in the same way as above except that they receive a food pellet located beneath or on the top of the novel object.

Object location: the test consists of one or more trials. A trial consists of a sample phase and a choice phase. In the sample phase animals are exposed to one object or more objects and in the choice phase they are re-exposed to the same objects but one was moved from the place it occupied in the sample phase to a different location. Normal animals spend more time with the novel object location than with a familiar object location.

Usually animals are not food deprived. However, the test can be performed with food reward and animals have to be food-deprived to run the test. The test is performed in the same way as above except that they receive a food pellet located beneath or on the top of the novel object.

1. An apparatus for studying the behavioural, cognitive, neurobiological and/or muscular processes of an animal, the apparatus comprising an elevated platform with at least one panel extending from the platform, said panel providing a surface which has a gradient relative to the platform.

2. The apparatus of claim 1, wherein the panel is adjustable to provide a surface that has a variable gradient relative to the platform.

3. The apparatus of claim 1, wherein the panel comprises two or more sections, the sections having different gradients to each other therefore providing more than one gradient in the panel relative to the platform.

4. The apparatus of claim 1, wherein one or more food and/or water rewards or visual stimuli are located in the apparatus.

5. The apparatus of claim 1, wherein the panel has a stand located at the end distal from the platform, the stand providing a substantially horizontal surface.

6. The apparatus of claim 5, wherein the stand is not visible to an animal located on the platform.

7. The apparatus of claim 1, wherein the platform has at least one edge adjacent a void space.

8. The apparatus of claim 1, wherein a structure is placed in the central area of the apparatus.

9. The apparatus of claim 8, wherein the structure is a tile or a similar object, which occupies the total surface of the central area.

10. The apparatus of claim 10, wherein a hub is provided on the elevated platform, said hub having at least one opening for passage of the animal.

11. The apparatus of claim 10, wherein the hub is substantially cylindrical and has between 3 to 8 openings.

12. The apparatus of claim 1, wherein the height of the elevated platform is adjustable.

13. The apparatus of claim 1, wherein the height of the elevated platform is around 70 to 75 cm.

14. The apparatus of claim 1, wherein the panel provides a gradient of between 60° to 80°, preferably 77°, relative to the platform.

15. The apparatus of claim 1, wherein the platform has a central area, inner area and outer area, said outer area comprising areas adjacent to a panel and areas adjacent to a void space.

16. The apparatus of claim 1, wherein the behaviour is anxiety.

17. The apparatus claim 1, wherein the platform is substantially square or rectangular, and there are two panels located on opposites sides of the platform.

18. The apparatus of claim 1, wherein the animal has been subjected to lesions, electrical brain stimulation or other interruptive modifications; the animal has one or more genetic modifications; and/or the animal has been administered a test agent.

19. The apparatus of claim 18, wherein the test agent is a drug-like molecule, one or more cells, a viral vector, a biological molecule, and/or a sRNAi molecule.

20. A method of studying the behavioural, cognitive, neurobiological and/or muscular processes of an animal, the method comprising placing one or more animals on the apparatus according to any of the previous claims and recording the frequency and/or duration the animal is located at one or more positions on the apparatus, and/or the latency of the animal to enter an area of the apparatus.

21. The method of claim 20, wherein the behavioural, cognitive, neurobiological and/or muscular processes includes anxiety, object preference/discrimination, sensory perception, memory, inter-animal competition, muscle tension and grip, and central nervous system function.

22. The method of claim 19, wherein the animal has been subjected to lesions, electrical brain stimulation or other interruptive modifications; and/or the animal has one or more genetic modifications.

23. A method of determining the effect of a test agent on animal behavioural, cognitive, neurobiological and/or muscular processes, comprising placing one or more said animals administered the test agent on the apparatus according to any of the previous claims and recording the frequency and/or duration the animal is located at one or more positions on the apparatus, and/or the latency of the animal to enter an area of the apparatus.

24. A method of measuring tolerance, dependence and withdrawal of an animal to a test agent which affect behavioural, cognitive, neurobiological and/or muscular processes, comprising placing one or more animal having been exposed to such a treatment for a period of time on the apparatus according to any of the previous claims and recording the frequency and/or duration the animal is located at one or more positions on the apparatus, and/or the latency of the animal to enter an area of the apparatus.

25. The method of claim 23, wherein the test agent is a drug-like molecule, one or more cells, a viral vector, a biological molecule, and/or a siRNA molecule.

26. An animal cognitive, neurobiological and/or muscular processes investigation apparatus, comprising an elevated platform with at least one panel extending from the platform, said panel providing a surface which has a gradient relative to the platform.
